(19) United States
(12) Patent Application Publication
(10) Pub. No.: US 2010/0118434 A1
(43) Pub. Date: May 13, 2010

(54) STORAGE APPARATUS AND CONTROL METHOD OF STORAGE APPARATUS

(75) Inventor: Hiroaki Inoue, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 12/571,151

(22) Filed: Sep. 30, 2009

(30) Foreign Application Priority Data
Nov. 12, 2008 (JP) 2008-290355

(51) Int. Cl. G11B 21/02

(52) U.S. Cl. 360/75; G9B/21.003

(57) ABSTRACT

According to one embodiment, a storage apparatus includes: a storage medium configured to include a plurality of tracks; a head configured to write data to the storage medium; an auxiliary storage module configured to be able to store the data; and a controller configured to determine, during data writing, a write start position of the data, move the head to a track to which the data is to be written, start writing the data along the track when the head reaches the track, and store a piece of the data to be written between the write start position and the position where the data is started to be written into the auxiliary storage module.

### CROSS-REFERENCE TO RELATED APPLICATIONS

This application is based upon and claims the benefit of priority from Japanese Patent Application No. 2008-290355, filed on Nov. 12, 2008, the entire contents of which are incorporated herein by reference.

### BACKGROUND

1. Field

One embodiment of the invention relates to a storage apparatus for storing data.

2. Description of the Related Art

Storage apparatuses storing a large amount of data are used for various usages. Typical examples of this type of storage apparatus are a magnetic disk apparatus, an optical disk apparatus, an optical magnetic disk apparatus, and the like. These storage apparatuses have a storage medium for storing data. The storage medium has a plurality of tracks.

A storage apparatus writes data in response to a write instruction from a higher-level device such as a Central Processing Unit (CPU).

The storage apparatus calculates a position where the data information should be written in the storage medium on the basis of a write command. The storage apparatus controls a head driver so that a head moves to a track including the calculated write start position of the data. However, when the head moves to the track to which the data should be written, the head positioned on the storage medium may not be positioned on top of the write start position on the storage medium. Since the storage apparatus writes information from the beginning of the data to the storage medium, the data cannot be written to the storage medium until the head reaches a write start position of the data on the storage medium.

Japanese Patent Application Publication (KOKAI) No. 2007-34536 discloses, for example, a technique related to writing data to a hybrid storage apparatus.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a hard disk apparatus according to an embodiment of the invention;

FIG. 2 is an exemplary schematic diagram illustrating a relationship between head movement on tracks and data writing in the embodiment;

FIG. 3 is an exemplary memory data management table in the embodiment;

FIG. 4 is an exemplary available area management table of a memory in the embodiment;

FIG. 5 is an exemplary flowchart of data write control in the embodiment;

FIG. 6 is an exemplary schematic diagram for explaining a data write operation of a controller in the embodiment;

FIG. 7 is an exemplary flowchart of the data write control in which data is written to a non-volatile memory in the embodiment;

FIG. 8 is an exemplary flowchart of data write control according to another embodiment of the present invention;

FIG. 9 is an exemplary graph illustrating a relationship between a seek distance and a seek time in the embodiment; and

FIG. 10 is an exemplary flowchart of the data read control in the embodiment.

### DETAILED DESCRIPTION

Various embodiments according to the invention will be described hereinafter with reference to the accompanying drawings. In general, according to one embodiment of the invention, a storage apparatus includes: a storage medium configured to include a plurality of tracks; a head configured to write data to the storage medium; an auxiliary storage module configured to be able to store the data; and a controller configured to determine, during data writing, a write start position of the data, move the head to a track to which the data is to be written, start writing the data along the track when the head reaches the track, and store a piece of the data to be written between the write start position and the position where the data is started to be written into the auxiliary storage module.

According to another embodiment of the invention, a control method of a storage apparatus having a storage medium configured to include a plurality of tracks, a head configured to write data to the storage medium, and an auxiliary storage module configured to be able to store the data, the control method includes: determining a write start position of the data during data writing; moving the head to a track to which the data is to be written; and starting writing the data along the track when the head reaches the track, and storing a piece of the data to be written between the write start position and the position where the data is started to be written into the auxiliary storage module.

Hereinafter, an embodiment will be described. Although the embodiment is described using a hard disk as its storage medium, the embodiment is not limited thereto.

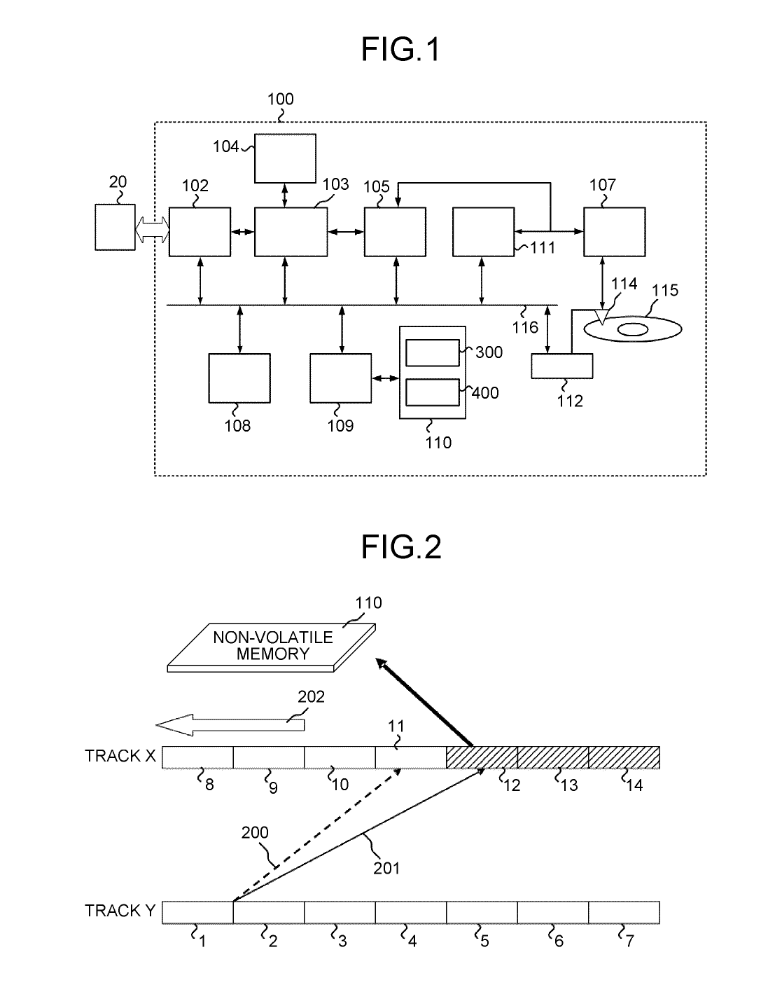

FIG. 1 is a block diagram of a storage apparatus 100 according to the embodiment. The storage apparatus 100 includes a host interface (IF) controller 102, a data buffer controller 103, a data buffer 104, a format controller 105, a head integrated circuit (IC) 107, a controller 108, a memory controller 109, a non-volatile memory 110, a disk 115, a voice coil motor (VCM) 112, a position detector 111, a head 114, and a common bus 116.

The host IF controller 102 controls transmission/reception of data between a higher-level apparatus 20 such as a personal computer (PC) and the storage apparatus 100. The data buffer controller 103 controls writing data to the data buffer 104 and reading data from the data buffer 104. The data buffer 104 temporarily stores a write command, a write data, and the like, transmitted from the higher-level apparatus 20.

The format controller 105 writes data to the disk 115 on the basis of the write command that is temporarily stored in the data buffer 104.

The head IC 107 code-modulates the write data output from the format controller 105, and writes the write data to the disk 115 by using the head 114.

The controller 108 integrally controls an overall operation of the storage apparatus 100. The controller 108 is realized by, for example, a micro processing unit (MPU). The non-volatile memory 110 is an auxiliary storage module for holding stored data even when power supply to the storage apparatus 100 is cut off. A volatile memory such as a static random access memory (SRAM) maybe used instead of the non-volatile memory 110 to hold the data by a small-sized battery when the power supply is cut off. The non-volatile memory 110 stores a memory data management table 300, an available area management table 400, a program executed by the controller 108, and the like. Details of the memory data management table 300 and the available area management table 400 will be described later.

The disk 115 is a storage medium in which information in the data is stored. The disk 115 has a plurality of tracks concentrically. Each track has a plurality of sectors. The information in the data is stored in the sector. The VCM 112 functions as a head driver for moving the head 114 to a predetermined position in accordance with a control command from the controller 108. The head 114 writes data to the sectors on the disk 115.

The information in the data and position information unique to each sector are stored in the sectors on the disk 115. The head 114 reads the information in the data and the position information from the disk 115. The position detector 111 detects position information corresponding to current position of the head 114 relative to the disk 115 from the information in the data and the position information read by the head 114, and outputs the position information. The common bus 116 is a bus for connecting the host IF controller 102, the data buffer controller 103, the format controller 105, the controller 108, the memory controller 109, and the VCM 112. Each module can transmit/receive data via the common bus 116.

The higher-level apparatus 20 transmits a write command and a write data to the storage apparatus 100. Here, a data write start address (Logical Block Address: LBA) is written in the write command. Further, the write data corresponds to the write command. The write command and the write data received from the higher-level apparatus 20 is held in the data buffer 104 by the data buffer controller 103. The controller 108 detects the current position of the head 114 by the position detector 111. The controller 108 determines a write start position of the information in the data on the disk 115. Specifically, the controller 108 calculates a write-start-sector number, a track number, a head number, and the like in the storage apparatus 100 from the LBA written in the write command. The controller 108 rearranges write commands so that a head moving distance becomes the shortest on the basis of the current position information of the head 114 and the calculated write-start-sector number. Consequently, the controller 108 can reduce time loss during the data writing. Such rearrangement of the write commands is called reordering, and execution order of the rearranged write commands is called a seek schedule.

The controller 108 executes the write commands in accordance with the seek schedule. The controller 108 controls the VCM 112 which is the head driver, so that the head 114 moves to a track to which the data is to be written. When the head 114 moves to the track to which the data is to be written and the position of the head 114 (head position) on the disk 115 corresponds to the write start sector which is the write start position, the controller 108 writes the data from the write start sector.

When the head 114 is moved to the track to which the data is to be written so that the head position on the disk 115 is moved to a sector corresponding to the middle of information in the data, the controller 108 cannot write the data from the write start sector. In this case, when the head 114 reaches the sector to which the data is to be written, the controller 108 starts writing the data along the track. Among all pieces of data to be written, the controller 108 stores a piece of the data to be written between the write start position and a position where the data is started to be written, into the non-volatile memory 110 which is an auxiliary storage module. In accordance with the above embodiment, data which has not been written into the disk 115 does not remain in the data buffer 104. Hence, the controller 108 can improve writing efficiency of the storage apparatus. In addition, there is no wait time for data writing when the position to which the head is moved differs from the write start sector. Therefore, the controller 108 can start writing the data to the storage apparatus 100 when the head 114 is moved to the track including the write start position.

When the head 114 is moved to the track to which the data is to be written, but the head position on the disk 115 is not moved to a sector corresponding to the middle of information in the data, the controller 108 cannot write the data to the disk 115. In this case, the controller 108 waits until the head 114 reaches the write start sector. When the head 114 reaches the write start sector, the controller 108 starts writing the data to the disk 115.

FIG. 2 is a schematic diagram illustrating a relationship between the head movement on a track and the data writing. A track Y includes sectors 1 to 7. A track X includes sectors 8 to 14. The disk 115 rotates in a direction of an arrow 202. The controller 108 moves the head 114 from the track Y to the track X in accordance with the seek schedule, and writes the data to the sectors 12 to 14 of the track X. According to a logical value calculated from a moving speed of the head 114 and a distance between the tracks, the head 114 reaches the sector 11 of the track X within a time as illustrated by an arrow 200.

However, in an actual operation, it is assumed that the head 114 reaches the sector 12 of the track X as illustrated by an arrow 201. In this case, since the data cannot be written from the sector 12, the controller 108 writes the data to the disk 115 from the sector 13. The controller 108 moves the data corresponding to the sector 12 and that could not be written to the disk 115, to the non-volatile memory 110 from the data buffer 104. By the above operation, the controller 108 can continue writing the data to the storage apparatus so that the unwritable data does not remain in the data buffer. In addition, the controller 108 can start writing the data to the storage apparatus 100 when the head 114 is moved to the track including the write start position.

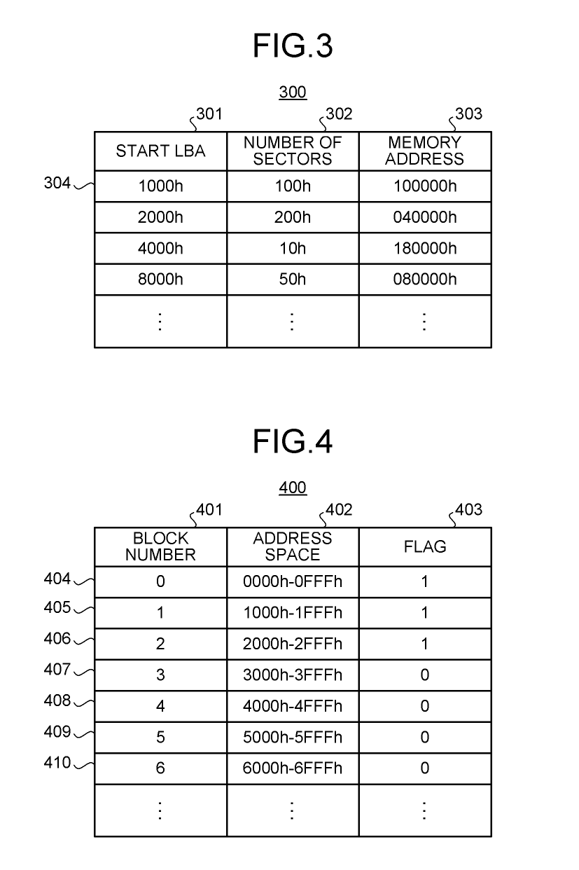

FIG. 3 is a table illustrating the memory data management table 300 for managing the unwritable data written in the non-volatile memory 110. The memory data management table 300 is stored in the non-volatile memory 110 in FIG. 1. The memory data management table 300 includes columns 301, 302, and 303. The column 301 represents start LBAs in a case where the unwritable data is written to the disk 115. The column 302 represents the total numbers of sectors in the case where the unwritable data is written to the disk 115. The column 303 represents memory addresses in the non-volatile memory 110 storing the unwritable data.

By referring to the memory data management table 300, the controller 108 can associate data written to the disk 115 with data written to the non-volatile memory 110 when reading the data. For example, by referring to a row 304, the controller 108 can find that the data which should have been written from the start LBA 1000h of the disk 115 to a 100h sector is written in an area started from a memory address 100000h in the non-volatile memory 110.

By referring to the memory data management table 300, the controller 108 can move the data moved to the non-volatile memory 110 to the disk 115 using spare time between the write commands. As described above, by referring to the row 304, the controller 108 can find that the data from the memory address 100000h is the data which should be written from the LBA 1000h of the disk 115. Therefore, the controller 108 can move the data from the memory address 100000h to the LBA 1000h of the disk 115 when there is no write command from the higher-level apparatus 20 in the data buffer 104. In the same way, the controller 108 can move the data of other rows. By moving the data in the non-volatile memory 110 to the disk 115 when there is no write command from the higher-level apparatus 20, the controller 108 can prevent a writable area to be disappeared from the non-volatile memory 110. By avoiding the writable area to be disappeared from the non-volatile memory 110, the controller 108 can avoid a case where the unwritable data in the data buffer 104 cannot be moved to the non-volatile memory 110. In this way, it is possible to improve writing efficiency of the storage apparatus 100.

FIG. 4 is a table illustrating the available area management table 400 for managing availability for each block when a data storage area of the non-volatile memory 110 is managed on block basis. The available area management table 400 is stored in the non-volatile memory 110 in FIG. 1. The available area management table 400 includes columns 401, 402, and 403. The column 401 represents block numbers assigned to each block when the data storage area of the non-volatile memory 110 is managed by block basis. The column 402 represents address spaces in the non-volatile memory 110 assigned to each block number. In the embodiment, one block has an address space of OFFFh bytes. The column 403 represents flags indicating availability of each block number. In the column 403, the flag “1” represents that the block is in use, and the flag “0” represents that the block is available. The rows 404 to 410 represent address spaces corresponding to each block number and availability information of the blocks.

For example, it is assumed that unwritable data of 3700h bytes is required to be moved to the non-volatile memory 110. In this case, the controller 108 refers to the column 403, and searches whether there are four consecutive rows with “0” flags. In the embodiment, the flags from row 407 to row 410 are “0”. Therefore, the controller 108 can recognize that there are consecutive available areas of 4000h bytes from the block number 3 to the block number 6. As described above, the controller 108 can search available memory areas in the non-volatile memory 110 with less processing by using the available area management table 400.

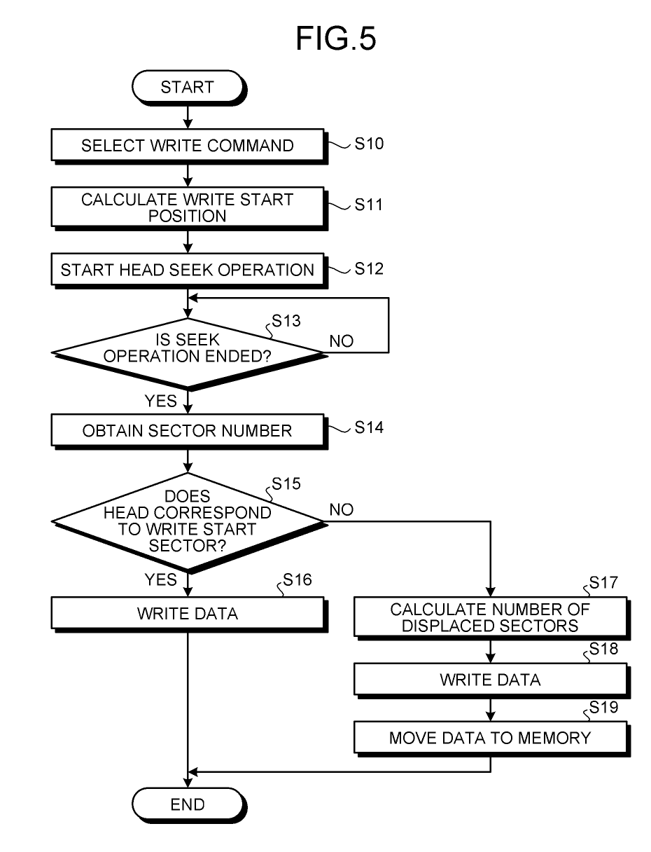

FIG. 5 is a flowchart of write control of the controller 108 when data is written from the higher-level apparatus 20 to the storage apparatus 100.

The controller 108 selects and executes write commands temporarily stored and reordered in the data buffer 104 in stored order in the data buffer 104 (S10). The controller 108 calculates the write-start-sector number which is the data write start position, the cylinder number including the write start sector, and the track number on the basis of the LBA written in the write command (S11).

The controller 108 starts a head seek operation, and controls the VCM 112, which is the head driver, so that the head is moved to a track corresponding to the calculated cylinder number and the track number (S12). The controller 108 continues to move the head until a track number output from the position detector 111 matches the calculated track number (No at S13). When the track number output from the position detector 111 matches the calculated track number and the seek operation ends (Yes at S13), the controller 108 obtains the sector number on which the head 114 currently exists from the position detector 111 (S14).

The controller 108 compares the sector number output from the position detector 111 and the write start sector number calculated on the basis of the LBA. The sector numbers of the disk 115 are set in ascending order or descending order. Therefore, by comparing largeness or smallness between the sector number output from the position detector 111 and the calculated sector number, it is possible to determine whether the head has passed over the write start sector.

As a result of the calculation, if the head 114 corresponds to the write start sector (Yes at S15), the controller 108 writes the data corresponding to the write command from the top of the data to the disk 115 (S16).

When the head 114 is displaced from the write start sector in the rotation direction of the disk 115 (No at S15), the controller 108 calculates the number of sectors corresponding to the displacement between the write start sector and the head 114 on the basis of the sector number output from the position detector 111 (S17). The controller 108 calculates the information in the data corresponding to the current head position on the basis of the number of displaced sectors. The controller 108 starts writing from the calculated information in the data to the disk 115 (S18). Even when the position of the head 114 is located before the write start sector corresponding to a beginning position of the data in the rotation direction of the disk 115, if there is data information corresponding to the current head position, the controller 108 writes the information corresponding to the current head position and the subsequent information into the disk 115. If there is no information corresponding to the current head position, the controller 108 waits until the head 114 reaches the write start sector.

The information in the data corresponding to the number of sectors displaced from the write start sector is not written to the disk 115 and remains in the data buffer 104. The controller 108 moves the information in the data which is not written to the disk 115 and remains in the data buffer 104 to a data storable area in the non-volatile memory 110 (S19).

By the above operation, the controller 108 moves the information to the non-volatile memory 110 so that the information in the data which was not written to the disk 115 does not remain in the data buffer 104. Consequently, the controller 108 can improve writing efficiency of the storage apparatus. In addition, there is no wait time for the data writing even when the head cannot be moved to the write start sector in time. Consequently, when the head is moved to the track to which the data is to be written while the head position on the storage medium differs from the calculated position corresponding to the beginning of the data, the data can be written to the storage apparatus.

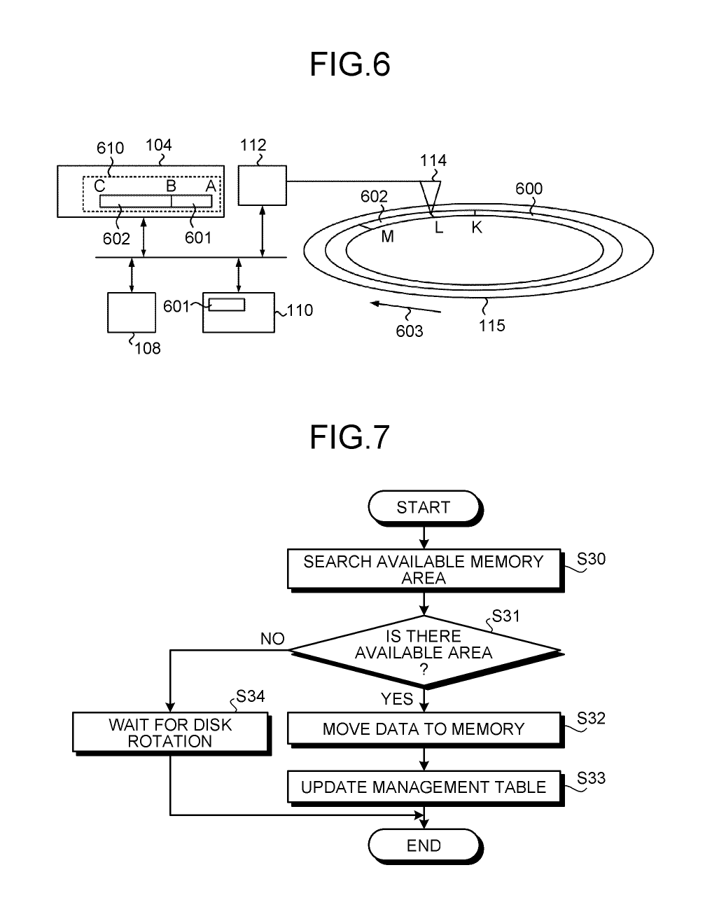

FIG. 6 is a schematic diagram illustrating the data writing of the controller 108. Data 610 is temporarily stored in the data buffer 104. The sector corresponding to the address A of the data 610 is the sector K in a track 600 of the disk 115, and the sector corresponding to the address C is the sector M. The controller 108 calculates the write start sector K of the disk 115 corresponding to the address A of the data 610 on the basis of the LBA written in the write command.

In order to write the data 610 stored in the data buffer 104 to the disk 115, the controller 108 controls the VCM 112 which is the head driver, and moves the head 114 to the track 600 including the sector K to which the data 610 is to be written. It is assumed that the head 114 is moved to the sector L of the track 600 so that the data writing is to be started from the sector L. Here, the information of the data 610 corresponding to the sector L is at the address B. Hence, the controller 108 writes the information 602 stored between the address B and the address C of the data 610 stored in the data buffer 104, in order, into the disk 115, from the sector L which is the position where the data writing is started.

Of the data 610 which is the write scheduled data, information 601 scheduled to be written between the write start sector K and the sector L corresponding to the position where the data is started to be written is not written to the disk 115 and remains in the data buffer 104. The controller 108 writes the information 601 remaining in the data buffer 104 to the non-volatile memory 110 which is an auxiliary storage module. As described above, when the head moves to the track, the data can be started to be written to the storage apparatus.

FIG. 7 is a detailed flowchart of moving data to the non-volatile memory 110 in S19 of FIG. 5. The controller 108 refers to the available area management table 400, and searches whether there is an available area able to record the number of sectors calculated in S18 in the non-volatile memory 110 (S30). When there is the available area in the non-volatile memory 110 (Yes at S31), the controller 108 moves the unwritable data stored in the data buffer 104 to the searched available area in the non-volatile memory 110 (S32). The controller 108 writes the start LBA, the number of sectors, and the memory address of the data moved to the non-volatile memory 110 to the memory data management table 300, and rewrites the flag of the block in which the data is written to “1” in the available area management table 400.

When there is no available area in the non-volatile memory 110 (No at S31), the controller 108 waits until the disk 115 rotates, and the write start sector reaches the position of the head 114 again. Thereafter, the controller 108 writes the data to the write start sector and the subsequent sectors of the disk 115. In this way, even when there is no available area in the non-volatile memory 110, the controller 108 can continue the data write processing.

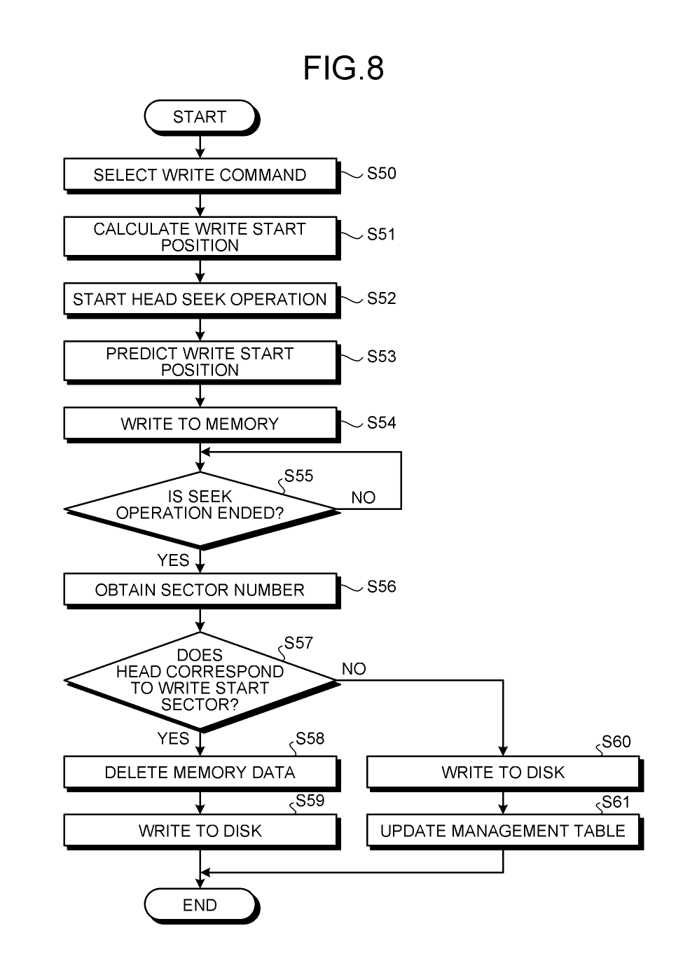

FIG. 8 is a flowchart of data write control of the controller 108 according to another embodiment. The write speed to the non-volatile memory 110 is very slow compared with the write speed to the disk 115. In the write data of a write command, when the amount of unwritable data moved to the non-volatile memory 110 is large, the write speed of the entire storage apparatus may be slow due to the data move to the non-volatile memory 110. In this case, the write control described below is effective.

The controller 108 selects and executes the write commands temporarily stored and reordered in the data buffer 104 in stored order in the data buffer 104 (S50). The controller 108 calculates the write start sector number which is the data write start position, the cylinder number including the write start sector, and the track number on the basis of the LBA written in the write command (S51). The controller 108 starts a head seek operation, and moves the head to the track corresponding to the calculated cylinder number and the track number (S52).

The controller 108 predicts the position where the data is started to be written when the head 114 moves to the track to which the data is to be written (S53). The controller 108 writes the data to be written between the write start position of the data and the predicted position where the data is actually started to be written, into the non-volatile memory 110 (S54). The prediction of the position where the data is started to be written will be described later. The controller 108 continues to move the head until a track number transmitted from the position detector 111 matches the calculated track number (No at S55). When the track number transmitted from the position detector 111 matches the calculated track number and the seek operation is ended (Yes at S55), the controller 108 obtains the sector number on which the head 114 currently exists from the position detector 111 (S56). The controller 108 compares the sector number obtained from the position detector 111 and the calculated write start sector number. When the obtained sector number matches the write start sector number (Yes at S57), the controller 108 deletes the data written in the non-volatile memory 110 (S58). At the same time, the controller 108 writes the data corresponding to the selected write command to the disk 115 (S59).

When the obtained sector number does not match the write start sector number (No at S57), the controller 108 writes the information on the write data corresponding to the sector which the head 114 reaches and the subsequent information into the disk 115 (S60). At the same time, the controller 108 writes the start LBA, the number of sectors, and the memory address of the information written to the non-volatile memory 110 to the memory data management table 300, and rewrites the flag of the block in which the information is written to “1” in the available area management table 400 (S61). As described above, the information on the data corresponding to the write start position predicted to be differing from the position where the head 114 reaches is preliminarily written in the non-volatile memory 110. Consequently, even when the data is written in response to the write command and the information transfer amount of the data to the non-volatile memory 110 is large, a slowdown of the write speed of the entire storage apparatus due to writing the information to the non-volatile memory 110 can be prevented.

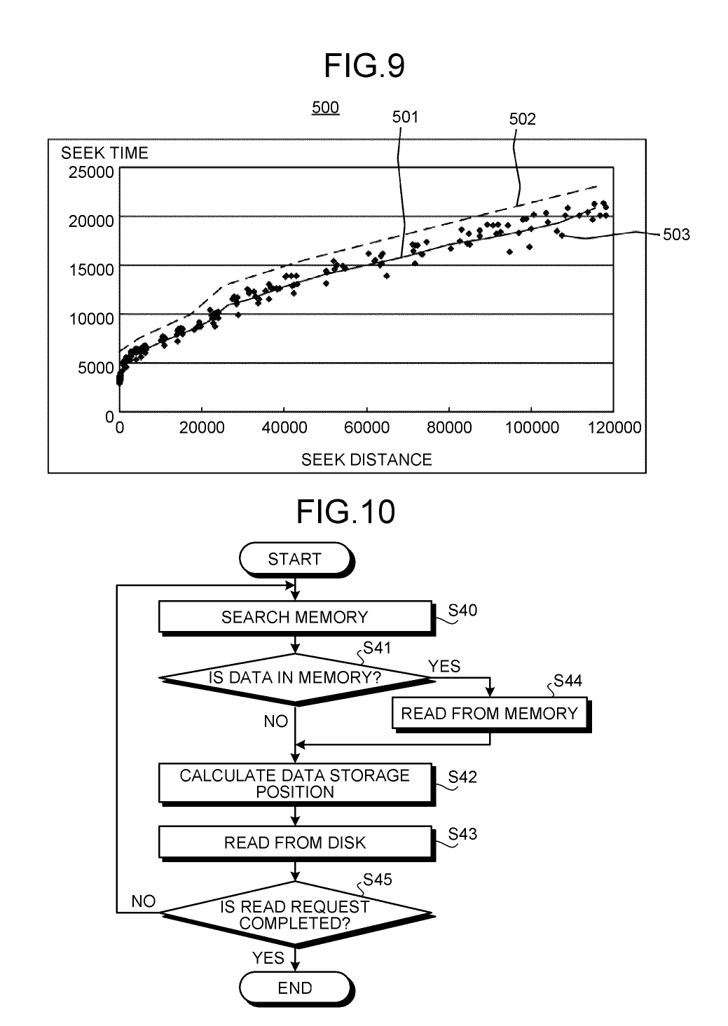

FIG. 9 is a graph 500 illustrating a relationship between a seek distance and a seek time of the head 114 corresponding to the seek distance. The seek distance is the number of tracks between a track on which the head 114 is currently located and a track to which the head 114 is to be moved. The seek time is the time required for the head to move over the seek distance. In the graph 500, a curve 501 is a theoretical value calculated from a head moving speed and a distance between the tracks. Points 503 are values measured by actually operating the storage apparatus. As shown by the points 503, since the actual seek time varies with respect to the theoretical value, when making a seek schedule on the basis of the theoretical value, the write start sector may be displaced from the position which the head 114 reaches.

A curve 502 graphically illustrates the relationship between the seek distance and the seek time considering seek time variation. The number of sectors corresponding to the displacement between the position which the head 114 reaches and the write start sector can be predicted from the seek time difference between the curves 501 and 502 at a given seek distance and the rotation speed of the disk 115. By storing the number of the sectors to an available area in the non-volatile memory 110 or the like and reading the number of the sectors during the control flow of FIG. 8, the controller 108 can write data corresponding to the number of the sectors which are predicted to be displaced in the seek operation of the head 114 into the non-volatile memory 110.

FIG. 10 is a flowchart of a read control of the controller 108 when data is read from the storage apparatus 100. In accordance with the read control, the controller 108 can read the data distributed to the disk 115 and the non-volatile memory 110.

The controller 108 refers to the memory data management table 300 and searches whether data corresponding to a data read command is stored in the non-volatile memory 110 (S40). When the data is not stored in the non-volatile memory 110 (No at S41), the controller 108 calculates the disk number, the track number, and the top sector number indicating the storage position of the data on the basis of the LBA written in the read command (S42). When a part of the data is stored in the non-volatile memory 110 (Yes at S41), the controller 108 reads the part of the data from the non-volatile memory 110 (S44). At the same time, by calculating the disk number, the track number, and the top sector number indicating the storage position of the data on the basis of the LBA written in the read command, and adding the number of the sectors of data stored in the non-volatile memory 110 to the top sector number, the controller 108 calculates the position in which the other part of the data is stored in the disk 115 (S42). The controller 108 reads the data from the disk 115 in accordance with the calculated sector number or the like (S43). When all the data read commands are not executed (No at S45), the controller 108 repeats the processing from S40 again. When all the data read commands are executed (Yes at S45), the controller 108 ends the reading.

According to the embodiment, in the storage apparatus, data can be stored regardless of the head position relative to the moving track. In other words, when writing data, once the head moves to the track including the write start scheduled position, it is possible to start writing the data to the storage apparatus.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A storage apparatus comprising:
a storage medium configured to include a plurality of tracks;
a head configured to write data to the storage medium;
an auxiliary storage module configured to be able to store the data; and
a controller configured to determine, during data writing, a write start position of the data, move the head to a track to which the data is to be written, start writing the data along the track when the head reaches the track, and store a piece of the data to be written between the write start position and the position where the data is started to be written into the auxiliary storage module.

2. The storage apparatus of claim 1, wherein the controller moves the data written into the auxiliary storage module to the storage medium.

3. The storage apparatus of claim 1, wherein the controller predicts the position on the storage medium where the data writing is to be started, and stores a piece of the data to be written between the write start position and the predicted position into the auxiliary storage module.

4. A control method of a storage apparatus having a storage medium configured to include a plurality of tracks, a head configured to write data to the storage medium, and an auxiliary storage module configured to be able to store the data, the control method comprising:
determining a write start position of the data during data writing;
moving the head to a track to which the data is to be written; and
starting writing the data along the track when the head reaches the track, and storing a piece of the data to be written between the write start position and the position where the data is started to be written into the auxiliary storage module.
